(19) United States
(12) Patent Application Publication
(10) Pub. No.: US 2019/0084147 A1
(43) Pub. Date: Mar. 21, 2019

(54) SCRUBBER

(71) Applicant: Anna WIEBE, Onoway (CA)

(72) Inventor: Anna WIEBE, Onoway (CA)

(21) Appl. No.: 15/710,936

(22) Filed: Sep. 21, 2017

(51) Int. Cl. B25J 1/02; B25J 19/00; B25J 15/04; A47L 13/16

(52) U.S. Cl. CPC B25J 1/02; A47L 13/16; B25J 15/04; B25J 19/0058

(57) ABSTRACT

Disclosed herein are scrubbers 100 comprising: a squeezable handle 102 having at least one grip 114; a head 106 having a pair of jaws 110, the head 106 configured to receive a scrubbing member 112; an arm 104 connecting the handle 102 to the head 106; and a cable connecting the handle 102 to the head 106. Also disclosed are methods of cleaning an item, the method comprising the steps of: obtaining the above-described scrubber; placing the item in the space between the jaws 110 of the head 106; squeezing the grips 114 of the head 102 such that the scrubbing member 112 is in contact with the item; moving the scrubber 100 along the length of the item; adjusting the force on the grips as the contours of the item changes along its length so as to maintain contact between the scrubbing member 112 and the item.

### FIELD OF THE INVENTION

The present invention is in the field of cleaning appliances. In particular, the present invention is in the field of long handle brushes.

### BACKGROUND OF THE DISCLOSURE

Office chairs and various parts of a banister, such as newels, newel bases, balusters, or handrails, provide a challenge to those who wish to clean them. The balusters and the horizontal spokes of an office chair base require body contortions that while at first do not seem to be a big concern, over time and over a great deal of cleaning, cause aches and pains in legs and lower back. Accordingly, a device is needed to assist cleaners with cleaning these difficult to reach parts.

### SUMMARY OF THE INVENTION

Disclosed herein are scrubbers 100 comprising: a squeezable handle 102 having at least one grip 114; a head 106 having a pair of jaws 110, the head 106 configured to receive a scrubbing member 112; an arm 104 connecting the handle 102 to the head 106; and a cable connecting the handle 102 to the head 106. Also disclosed are methods of cleaning an item, the method comprising the steps of: obtaining the above-described scrubber; placing the item in the space between the jaws 110 of the head 106; squeezing the grips 114 of the head 102 such that the scrubbing member 112 is in contact with the item; moving the scrubber 100 along the length of the item; adjusting the force on the grips as the contours of the item changes along its length so as to maintain contact between the scrubbing member 112 and the item.

### BRIEF DESCRIPTION OF THE DRAWINGS

FIG. 1 is a drawing of an embodiment of the disclosed scrubber.

### DETAILED DESCRIPTION OF THE EMBODIMENTS

### Parts List

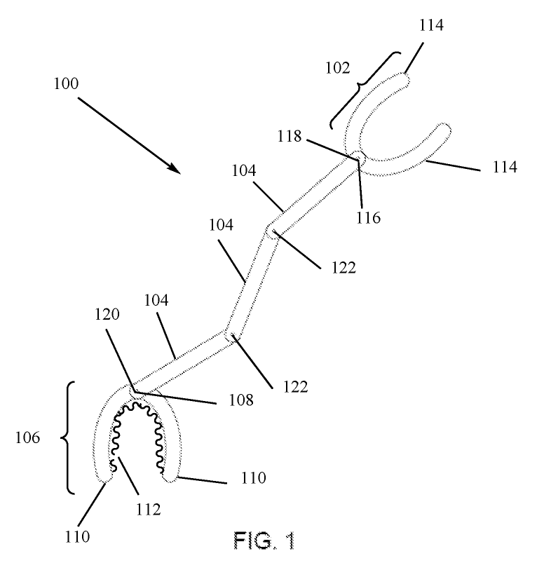

The following list of parts refers to the FIG. 1:
100: An embodiment of the disclosed device.
102: The device handle.
104: The device arm.
106: The device head.
108: Joint connecting the arms of the head.
110: A jaw of the head.
112: Scrubbing member.
114: A grip of the handle.
116: Joint connecting the arms of the handle.
118: Joint connecting the arm to the handle.
120: Joint connecting the arm to the head.
122: Joint(s) connecting the segments of the arm.

### DISCLOSURE

Disclosed herein are scrubbers that can be used to clean hard to reach places, or items that require bending down. The scrubbers disclosed herein are suitable for cleaning various parts of a banister, such as newels, newel bases, balusters, or handrails. The scrubbers can also be used to clean furniture, such as the base of office chairs.

In one aspect, the scrubbers disclosed herein comprise a squeezable handle at one end, and a pair of jaws having the scrubbing member at another end. Squeezing of the handle controls the width of the opening between the two jaws. By squeezing the handle and reducing the width of the opening, the user maintains a tight connection between the scrubbing member and the item being scrubbed.

The disclosed scrubber is now described more fully in view of FIG. 1. The scrubber 100 comprises a handle 102, an arm 104, and a head 106 configured to receive a scrubbing member 112. Further, a cable (not shown) connects the handle 102 to the head 106. In some embodiments, the cable runs through the interior of the arm 104, whereas in other embodiments, the cable is either entirely or partially exterior to the arm 104.

Throughout the present disclosure, the words “distal” and “proximal” are used to indicate the relative position of two or more objects. “Proximal” refers to closer proximity to the handle 102, whereas distal refers to closer proximity to the head 106. A first object is located “proximally” to a second object when the first object is located closer to the handle 102 than to the head 106. A first object is located “distally” to a second object when the first object is located closer to the head 106 than to the handle 102.

The handle 102 is a squeezable handle. The head 106 comprises two movable jaws. When the handle 102 is squeezed, the cable is moved, which in turn causes the jaws 110 of the head 106 to move towards or away from each other, i.e., the head 106 contracts or expands, respectively. The movement of the jaws 110 causes the space between the two jaws 110 to be reduced, which allows the user to maintain a tight connection between the scrubbing member 112 and the item being scrubbed.

In some embodiments, the handle 102 comprises two grips 114. The two arms pivot around a proximal joint 116. When the two grips 114 are squeezed such that the distance between them is reduced, the cable is pulled proximally. In some embodiments only one grip 114 is mobile in response to the squeezing and the other 114 remains stationary. In other embodiments, both grips 114 are mobile in response to the squeezing.

In other embodiments (not shown), the handle 102 roughly resembles a handgun, with a grip-like grip 114 and a trigger-like squeezable member. In these embodiments, pulling on the squeezable member causes the cable to be pulled proximally.

Throughout the present disclosure, by “squeezing the handle 102” it is meant that an act of squeezing is performed that causes the cable to be pulled proximally. This is regardless of the mechanism used to pull the cable.

In some embodiments, the cable is a contiguous cable that connects the handle 102 to the head 106. In other embodiments, the cable is fragmented into two or more segments. In these embodiments, even though the cable is not contiguous, nevertheless, over its entirety, it provides the means that connects the handle 102 to the head 106 such that squeezing the handle 102 causes the head 106 to contract.

The cable can be made from any material. One of the requirements for the cable is that it needs to be strong enough so that it does not snap when the handle 102 is squeezed. In some embodiments, the cable is made from a metal, a natural polymer, or a synthetic polymer. Thus, the cable can be a rope, string, piano wire, electrical wire, and the like. Examples of materials that can be used for the makeup of the cable include, but are not limited to, steel, copper, brass, aluminum, cotton, hemp, burlap, nylon, and plastic.

The arm 104 connects the handle 102 to the head 106. In some embodiments, the arm 104 is a single piece, rigid member. In other embodiments, the arm 104 comprises two or more segments that are connected through joints. The embodiment shown in FIG. 1 illustrates an embodiment in which the arm 104 comprises three segments. In the embodiments where the arm 104 is two or more segments, each segment terminates in a proximal and a distal joint.

The proximal-most segment of the arm 104 connects to the handle 102 at the joint 118. Throughout the present disclosure, joint 116 refers to the joint where the grips 114 come together, whereas joint 118 refers to the joint where the proximal-most segment of the arm 104 joins the handle 102. The skilled artisan recognizes that in some embodiments, for example the embodiment shown FIG. 1, joint 116 and joint 118 are one and the same, whereas in other embodiments, the two joints are different.

In some embodiments arm 104 pivots around the joint 118, whereas in other embodiments, the joint 118 is stiff and does not rotate.

The distal-most segment of the arm 104 connects to the head 106 at the joint 120. Throughout the present disclosure, joint 108 refers to the joint where the jaws 110 come together, whereas joint 120 refers to the joint where the distal-most segment of the arm 104 joins the head 106. The skilled artisan recognizes that in some embodiments, for example the embodiment shown FIG. 1, joint 120 and joint 108 are one and the same, whereas in other embodiments, the two joints are different.

In some embodiments arm 104 pivots around the joint 120, whereas in other embodiments, the joint 120 is stiff and does not rotate.

In embodiments where the arm 104 comprises two or more segments, there is one or more joint 122 connecting the segments together. In some embodiments the arm 104 segments pivot around the joint(s) 122, whereas in other embodiments, the joint(s) 122 is(are) stiff and do(es) not rotate. In embodiments where there are more than one joints 122, each joint is independently stiff or rotatable.

In some embodiments, each of the joints 108,116,118,120,122 independently comprises a friction lock, where when the arms that pivot about the joint are moved to a new position, the new position is retained throughout the use of the device 100 until the user repositions the arms in a new position. In other embodiments, the user releases the friction lock, for example by turning a knob, positions the arms in a desired position, and then re-applies the friction lock.

The head 106 configured to receive a scrubbing member 112. The scrubbing member may be a brush, cloth, sponge, paper towel, or any other cleaning or wiping device known now or developed later. In some embodiments, the head 106 comprises members (not shown) to which the scrubbing member 112 is attached. The connecting members include, but are not limited to, hooks, snags, snaps, Velcro, friction lock, and the like.

In some embodiments, the scrubbing member 112 and the head 106 are one piece. In these embodiments, the head 106 is detachable at the joint 108, or at any other point along the arm 104, for example at a point that includes the distal-most segment of the arm 104. The user then replaces one head 106 for another head 106, to introduce either a clean replacement for a dirty scrubbing member 112, or for changing the nature of the scrubbing member 112, for example from a brush to a sponge.

During use, the user holds the handle 102 in their hand and puts the head 106 and the scrubbing member 112 on the article to be wiped or cleaned. To get the best fit and the best reach, the user may rotate the joints 122, if present, to create the correct angle for the arm 104 to reach the article. The user then squeezes the handle 102 to reduce the interior diameter of the head 106 such that the jaws 110 snuggly encircle the article. The user can then adjust the interior diameter of the head 106 by loosening or squeezing the grip on handle 102 in response to the changes in the contour of the article. By using the device 100 and the methods described herein, the user maintains constant contact with the majority of the surfaces of the article without the need to bend down or contort the user's body in any way.

What is claimed is:

1. A scrubber 100 comprising:
a squeezable handle 102 having at least one grip 114;
a head 106 having a pair of jaws 110, the head 106 configured to receive a scrubbing member 112;
an arm 104 connecting the handle 102 to the head 106; and
a cable connecting the handle 102 to the head 106.

2. The scrubber of claim 1, wherein the cable runs through the interior of the arm 104.

3. The scrubber of claim 1, wherein the cable is either entirely or partially exterior to the arm 104.

4. The scrubber of claim 1, wherein the handle 102 comprises two grips 114.

5. The scrubber of claim 1, further comprising a proximal joint 116, about which at least one grip 114 pivots.

6. The scrubber of claim 5, wherein both grips 114 pivot about the proximal joint 116.

7. The scrubber of claim 1, wherein the cable is a contiguous cable that connects the handle 102 to the head 106.

8. The scrubber of claim 1, wherein the cable is fragmented into two or more segments.

9. The scrubber of claim 1, wherein the arm 104 is a single piece, rigid member.

10. The scrubber of claim 1, wherein the arm 104 comprises two or more segments that are connected through joints.

11. The scrubber of claim 1, wherein the arm 104 comprises two or more segments, and one or more joint 122 connects the segments together.

12. The scrubber of claim 1, wherein the scrubbing member is a brush, cloth, sponge, or paper towel.

13. A method of cleaning an item, the method comprising the steps of:
obtaining a scrubber of claim 1;
placing the item in the space between the jaws 110 of the head 106;
squeezing the grips 114 of the head 102 such that the scrubbing member 112 is in contact with the item;
moving the scrubber 100 along the length of the item;
adjusting the force on the grips as the contours of the item changes along its length so as to maintain contact between the scrubbing member 112 and the item.
